(19) United States
(12) Patent Application Publication
(10) Pub. No.: US 2006/0192005 A1
(43) Pub. Date: Aug. 31, 2006

(54) Image display apparatus

(76) Inventors: Yoshihisa Narui, Saitama (JP); Taro Tadano, Chiba (JP); Yoshiki Kawai, Kanagawa (JP); Kazushige Tsurumi, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/352,375

(22) Filed: Feb. 13, 2006

(30) Foreign Application Priority Data
Feb. 25, 2005 (JP) P2005-051526

(51) Int. Cl. G06K 7/00; G06K 7/08

(52) U.S. Cl. 235/439; 235/451

(57) ABSTRACT

An image display apparatus has a reader/writer for a contactless IC card, which is disposed at a position adjacent to a display section of the image display apparatus.

### BACKGROUND OF THE INVENTION

1. Field of the Invention

The present invention relates to an image display apparatus suitable for applying to a so-called public display placed in airport lounges, in front of stations, in other public facilities or the like, to display various information, advertisements and the like.

2. Description of Related Art

In airport lounges, in front of stations, in other public facilities and the like, there is usually placed a so-called public display. Various information and advertisements from information sources such as servers of advertising management companies and the like are transferred as video signals to such public display by means of wired, wireless or internet, and are displayed on the public display (refer to Japanese Patent Application Publications No. HEI 9-325992 and No. 2003-323165).

### SUMMARY OF THE INVENTION

Heretofore, on such public display in a related art, it has only so far displayed various information, advertisements and the like.

In view of the present circumstances, the present invention is aimed to use an image display apparatus such as a public display more effectively.

An image display apparatus according to an embodiment of the present invention has a reader/writer for a contactless IC card, which is disposed at a position adjacent to a display section thereof.

According to an embodiment of the present invention, by disposing the reader/writer for a contactless card IC at a position adjacent to the display section of the image display apparatus, the image display apparatus such as a public display can be used further effectively.

Further, according to an embodiment of the present invention, for example, images captured by a mobile phone can be displayed on the display section of the image display apparatus through a personal computer connected the reader/writer.

Furthermore, according to an embodiment of the present invention, coupon information related to an advertisement displayed on the display section of the public display can be distributed through the reader/writer to the contactless IC card owned by a consumer.

### BRIEF DESCRIPTIONS OF THE DRAWINGS

FIG. 1 is a block diagram showing an example of an image display apparatus according to an embodiment of the present invention;

FIG. 2 is a plan view showing a main portion example of an embodiment of the present invention;

FIG. 3 is a cross-sectional view of FIG. 1 taken along with the line III-III;

FIG. 4 is a block diagram to be used in explanation of an embodiment of the present invention;

FIG. 5 is a block diagram of a mobile phone having a contactless IC card function;

FIG. 6 is a block diagram to be used in explanation of an embodiment of the present invention; and

FIG. 7 is a flow chart to be used in explanation of an embodiment of the present invention.

### DESCRIPTION OF THE EMBODIMENT(S)

In the following, an image display apparatus according to an embodiment of the present invention will be described with reference to the drawings.

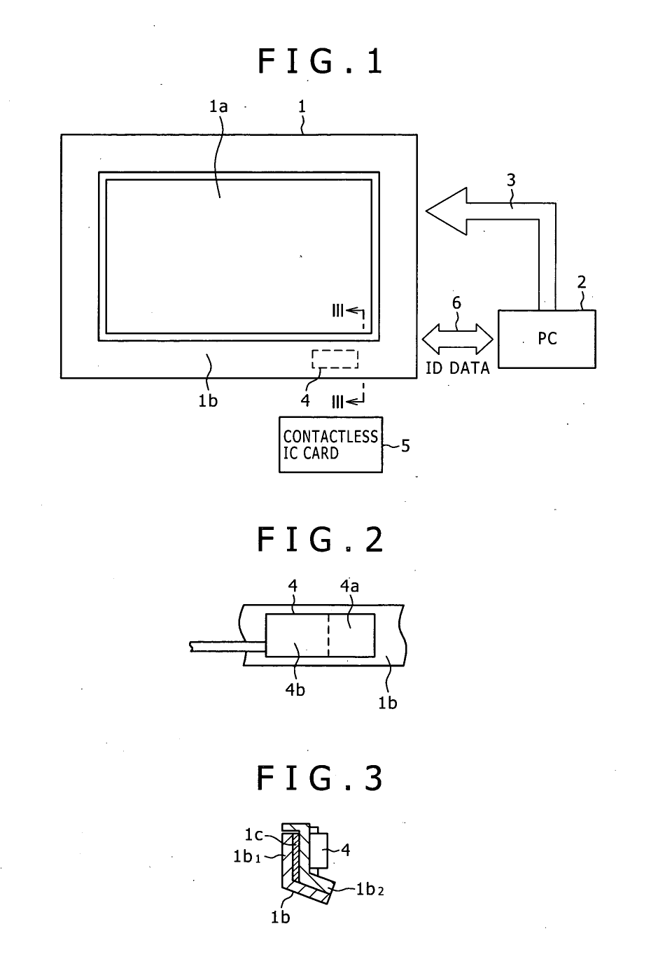

In FIG. 1, numeral 1 indicates an image display apparatus constituting a public display. A display section 1a of the image display apparatus 1 is composed of LCD, PDP and the like, to configure the image display apparatus 1 thin.

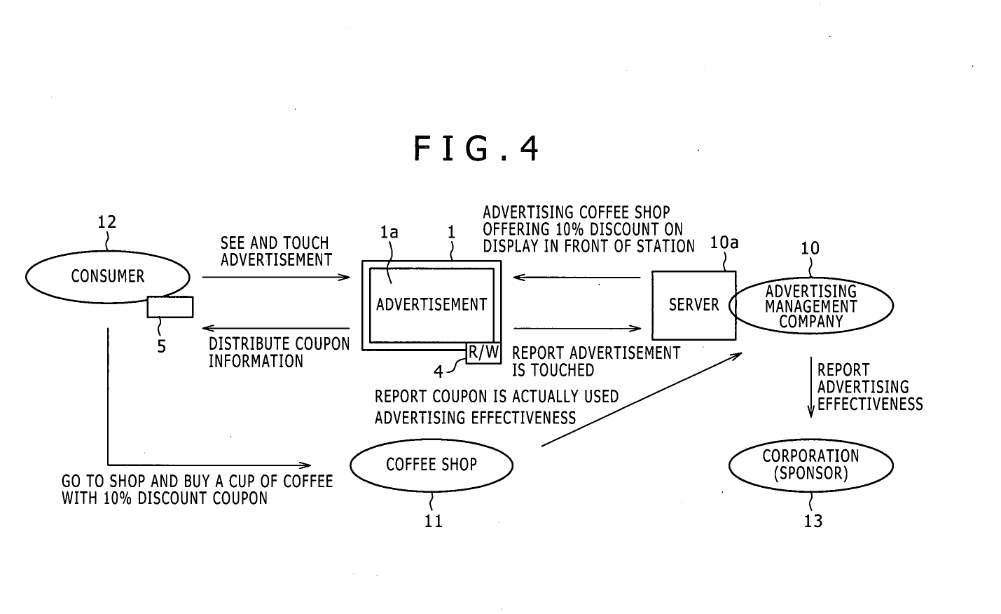

The image display apparatus 1 causes a personal computer 2 located nearby to download and store image data from a server 10a stored data such as advertisements and owned by an advertising management company 10, and displays the image data on the display section 1a, as shown in FIG. 4.

The image display apparatus 1 and the personal computer 2 are connected with a video cable 3, and the image data stored in the personal computer 2 is supplied to the image display apparatus 1 through the video cable 3 to be displayed on the display section 1a.

In this example, a reader/writer 4 performing reading from and writing to a contactless IC card 5, such as FeliCa (registered trademark), is disposed at a position adjacent to the display section 1a of the image display apparatus 1, for example, at a position on the back surface of a front bezel 1b constituting the outer frame of the display section 1a.

This reader/writer 4 is a well-known one, having an antenna 4a and a controller 4b, which are modularized as shown in FIG. 2. In the present embodiment, as shown in FIGS. 1 to 3, a recess is formed in a predetermined position at a lower right side of the back surface of the bezel 1b and the reader/writer 4 is, for example, adhesively fixed so as to fit there.

As shown in FIG. 3, the bezel 1b has a double-layered structure constructed of an outer resin 1b1 and an inner resin 1b2. The outer resin 1b1 is made of transparent acrylic whose back surface is coated with pearl, black or silver color, and the inner resin 1b2 is made of ABS. The outer resin 1b1 and the inner resin 1b2 are adhered each other with double-faced adhesive tape 1c.

It is to be noted that, although it is not shown, on the front surface of the bezel 1b, a mark indicative of presence of the antenna 4a is shown at a position corresponding to a position where the antenna 4a of the reader/writer 4 is located.

The contactless IC card 5 has an antenna and an IC-chip as well known in the art, which are formed in a card shape. When the contactless IC card 5 is brought close to the antenna 4a of the reader/writer 4 from the front side of the bezel 1b (hereinafter, it is described as “touch”), the reader/writer 4 reads ID data of the contactless IC card 5 or writes predetermined data thereto.

Communication between the contactless IC card 5 and the reader/writer 4 is performed by means of electromagnetic waves emitted from the reader/writer 4.

The reader/writer 4 is connected via a USB cable 6 to the personal computer 2 placed at a position adjacent to the image display apparatus 1. When the contactless IC card 5 is touched to the antenna 4a of the reader/writer 4 of the image display apparatus 1, data stored in the contactless IC card 5 can be transmitted to the personal computer 2, or data stored in the personal computer 2 can be transmitted to the contactless IC card 5.

With reference to FIG. 4, next description is made on an example that the reader/writer 4 of the image display apparatus 1 serving as a public display distributes coupon information related to an advertisement displayed on the display section 1a.

For example, the personal computer 2 (not shown in FIG. 4) of the image display apparatus 1 placed in front of a station downloads from a server 10a of an advertising management company 10 an advertisement of a coffee shop 11 offering 10% discount, and displays this advertisement on the display 1a of the image display apparatus 1 in order to advertise the coffee shop offering 10% discount.

At this time, if a consumer 12 sees the advertisement and touches his/her contactless IC card 5 to the antenna 4a of the reader/writer 4 of the image display apparatus 1, the personal computer 2a informs a fact that the consumer 12 sees the advertisement and touches his/her contactless IC card 5 to the antenna 4a of the reader/writer 4 of the image display apparatus 1 to the server 10 of the advertising management company 10, and coupon information offering 10% discount is distributed to the contactless IC card 5 owned by the consumer 12.

After that, when the consumer 12 goes with his/her contactless IC card 5 to the coffee shop 11 who has advertised 10% discount and purchases a cup of coffee with the 10% discount coupon information stored in his/her contactless IC card 5, the coffee shop 11 reports the fact of purchasing to the advertising management company 10, and consequently, the advertising management company 10 can report advertising effectiveness to a corporation 13 who is a sponsor of the advertisement of the coffee shop 11.

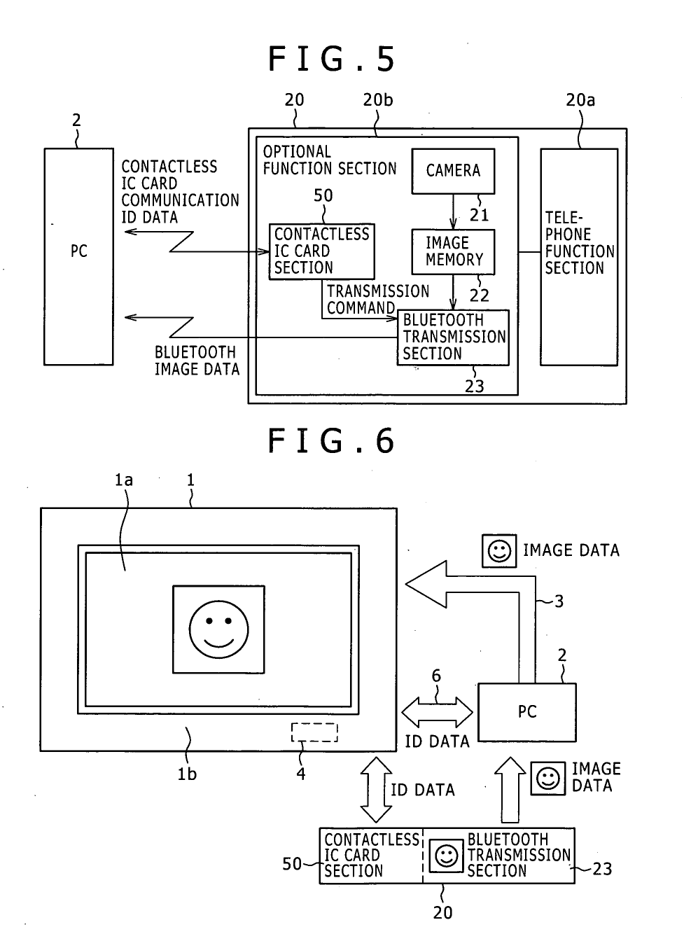

With reference to FIGS. 5 to 7, next description is made on a case where a contactless IC card function is incorporated in a mobile phone to make a mobile phone 20 having a contactless IC card function, and image data captured by a camera of the mobile phone 20 is viewed by the image display apparatus 1 serving as a public display.

The mobile phone 20 has, as shown in FIG. 5, a telephone function section 20a known in the art and an optional function section 20b. The optional function section 20b includes a camera 21, an image memory 22 storing image data captured by the camera 21, a Bluetooth transmission section 23 transmitting image data stored in the image memory 22 via radio waves, and a contactless IC card function section 50. The contactless IC card function section 50 issues a transmission command to the Bluetooth transmission section 23.

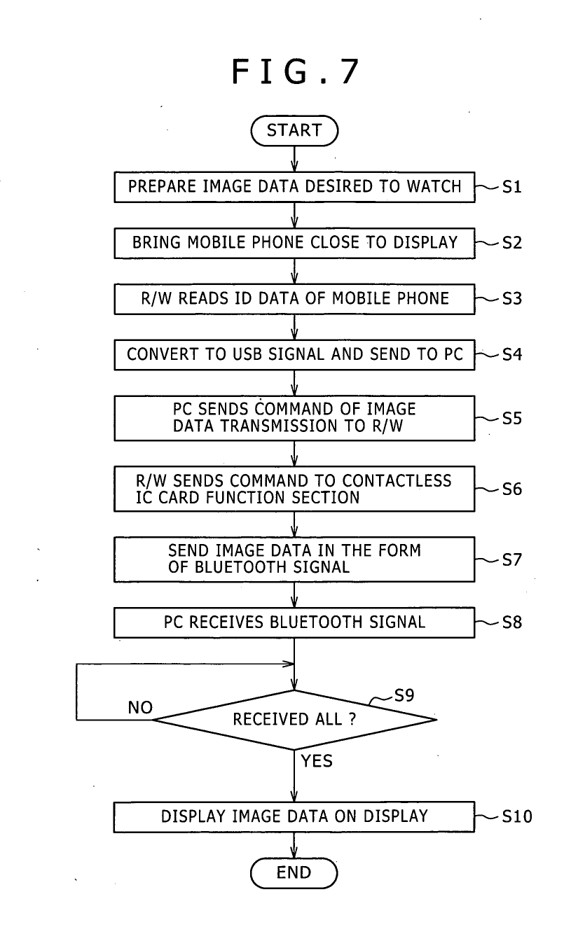

With reference to FIGS. 6 and 7, a case will be explained where image data captured by the camera 21 of the mobile phone 20 is displayed on the image display apparatus 1 serving as a public display having a large screen. First, image data desired to be displayed on the image display apparatus 1 is prepared (step S1).

Next, the contactless IC card function section 50 of the mobile phone 20 is touched to the antenna 4a of the reader/writer 4 of the image display apparatus 1 (step S2). At this time, the reader/writer 4 reads ID data of the contactless IC card function section 50 (step S3).

The reader/writer 4 converts the ID data into a USB signal and transfers the signal to the personal computer 2 via the USB cable 6 (step S4). The personal computer 2 issues a command of transmitting the image data to the reader/writer 4 (step S5).

After that, the reader/writer 4 sends the command to the contactless IC card function section 50 of the mobile phone 20 (step S6). The contactless IC card function section 50 issues a transmission command to the Bluetooth transmission section 23, and the Bluetooth transmission section 23 converts the image data transmitted from the image memory 22 into a Bluetooth signal and sends it to the personal computer 2 via radio waves (step S7).

The personal computer 2 receives the Bluetooth signal of the image data (step S8). The personal computer 2 determines whether or not all Bluetooth signals of the image data desired to be displayed (step S9) have been received. After determined all image data has been received, the image data is supplied to the image display apparatus 1 via the video cable 3 and displayed on the display section 1a of the image display apparatus 1 (step S10).

As described above, according to the present embodiment, by virtue of disposing adjacent to the display section 1 the reader/writer 4 for the contactless IC card 5 or for the contactless IC card section 50 of the mobile phone 20, it is possible to use the image display apparatus 1 serving as a public display further effectively.

According to the present embodiment, for example, image data captured by the mobile phone 20 can be displayed on the display section 1a of the image display apparatus 1 serving as a public display having a large screen, via the personal computer 2 connected to the reader/writer 4.

Further, according to the present embodiment, the reader/writer 4 can distribute coupon information related to an advertisement displayed on the display section 1a of the public display 1 to the contactless IC card 5 owned by the consumer 12, which enhances advertising effectiveness.

It is to be noted that the present invention is not limited to the above examples, and it is obvious that various structures can be made without departing from the gist of the present invention.

It should be understood by those skilled in the art that various modifications, combinations, sub-combinations and alterations may occur depending on design requirements and other factors insofar as they are within the scope of the appended claims or the equivalents thereof.

The present invention contains subject matter related to Japanese Patent Application JP2005-051526, filed in the Japanese Patent Office on Feb. 25, 2005, the entire contents of which being incorporated herein by reference.

What is claimed is:

1. An image display apparatus, comprising:
a reader/writer for a contactless IC card, disposed at a position adjacent to a display section of the image display apparatus.

2. The image display apparatus according to claim 1,
wherein the position adjacent to the display section is a predetermined position on a back surface of a bezel.

3. The image display apparatus according to claim 1,
wherein the reader/writer reads or writes data stored in a contactless IC card function provided in a mobile phone.

4. The image display apparatus according to claim 3,
wherein the display section displays image data captured by the mobile phone.

5. The image display apparatus according to claim 1,
wherein the reader/writer reads ID data of the contactless IC card.

6. The image display apparatus according to claim 1,
wherein the reader/writer distributes coupon information related to an advertisement displayed on the display section.
